(19) United States
(12) Patent Application Publication
(10) Pub. No.: US 2026/0066397 A1
(43) Pub. Date: Mar. 5, 2026

(54) ANODE FORMATION IN METAL-AIR CELLS

(71) Applicant: PHINERGY LTD., Kfar Sabba (IL)

(72) Inventors: Tovit DOBRIN, Kfar Yona (IL); Assaf ERAN, Raanana (IL); Matan KOLPAK, Rehovot (IL)

(73) Assignee: PHINERGY LTD., Kfar Saba (IL)

(21) Appl. No.: 19/106,048

(22) PCT Filed: Aug. 9, 2023
(86) PCT No.: PCT/IL2023/050828

§ 371 Date: Feb. 24, 2025

Related U.S. Application Data
(60) Provisional application No. 63/400,783, filed on Aug. 25, 2022.

(51) Int. Cl. H01M 12/02; H01M 12/08

(52) U.S. Cl. CPC H01M 12/02; H01M 12/08

(57) ABSTRACT

Metal-air cells, battery stacks, battery system and methods of forming the anodes within the metalair cells without dismantling the cell are provided. The anodes include metal mesh(es) as current collector(s) and concentrated slurry comprising metal granules suspended in electrolyte, in electrical contact with the current collector(s). The concentration of the slurry is carried out by circulating it through a cell space between cathode(s) and the metal mesh(es), which are configured to increase the concentration of the metal granules accumulating thereupon. The rise in required circulation pressure (or the corresponding time period and/or changes in conductivity related thereto) is used to indicate the completion of the anode formation process. One- and two-dimensional implementations of cells are provided, and discharging efficiency may be enhanced by circulating the electrolyte during discharging.

### BACKGROUND OF THE INVENTION

### 1. Technical Field

The present invention relates to the field of energy storage, and more particularly, to metal-air batteries.

### 2. Discussion of Related Art

U.S. Pat. Nos. 10,581,061 and 11,171,320, and U.S. Patent Application Publication No. 20220037637, which are incorporated herein by reference in their entirety, teach methods for renovation of a consumed anode in a metal-air cell.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides metal-air cell comprising: at least one air cathode with at least one associated separator, and at least one anode comprising: at least one current collector comprising at least one metal mesh, and a concentrated slurry comprising metal granules suspended in electrolyte that is accumulated within a cell space volume defined between the at least one separator associated with the at least one air cathode and the at least one current collector, the concentrated slurry being in electrical contact with the at least one current collector and the cell space volume being in fluid communication with a slurry entrance, and, through the metal mesh, in fluid communication with a filtrate exit.

One aspect of the present invention provides a battery stack comprising a plurality of the metal-air cells and a battery system comprising the battery stack, a slurry circulation unit configured to deliver the slurry to the slurry entrance at a first pressure P1 and remove the filtrate from the filtrate exit at a second pressure P2, and a controller configured to control at least one of the first and second pressures to control the accumulation of the metal granules of the concentrated slurry according to specified parameters (e.g., pressure difference, time duration, changes in conductivity, etc.).

One aspect of the present invention provides a method of forming an anode within a metal-air cell without dismantling the cell, the method comprising: (i) circulating, under a pressure difference, a slurry comprising metal granules suspended in electrolyte into a cell space volume and out through at least one metal mesh configured as at least one current collector of the metal-air cell, wherein the metal mesh is configured to filter slurry to concentrate the metal granules within the cell space volume, and (ii) stopping the circulation upon reaching a pressure difference threshold or a specified time period to yield the anode comprising a concentrated slurry and the at least one current collector, being in electrical contact, wherein the cell space volume is defined between the at least one separator associated with at least one air cathode and the at least one current collector, and is in fluid communication with a slurry entrance, and, through the metal mesh, in fluid communication with a filtrate exit of the metal-air cell.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIGS. 1A-1C are high-level schematic illustrations of a metal-air cell and a method of forming an anode therein, according to some embodiments of the invention.

FIGS. 2A-2E schematically illustrate embodiments of metal-air cells and cell stacks enabling formation of anodes without dismantling the cells, according to some embodiments of the invention.

FIGS. 3A-3D schematically illustrate embodiments of metal-air cells enabling anode formation without dismantling the cells, according to some embodiments of the invention.

FIG. 4 is a high-level schematic illustration of a battery system, according to some embodiments of the invention.

FIG. 5 provides experimental examples for improved discharging under continuous electrolyte circulation, according to some embodiments of the invention.

FIG. 6 is a high-level flowchart illustrating a method of forming an anode within a metal-air cell without dismantling the cell, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing”, “deriving” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention provide efficient and economical methods and mechanisms for forming anodes within the metal-air cells, and thereby provide improvements to the technological field of energy storage. Metal-air cells, battery stacks, battery system and methods of forming the anodes within the metal-air cells without dismantling the cell are provided. The anodes include metal mesh(es) as current collector(s) and concentrated slurry comprising metal granules suspended in electrolyte, in electrical contact with the current collector(s). The concentration of the slurry is carried out by circulating it through a cell space between cathode(s) and the metal mesh(es), which are configured to increase the concentration of the metal granules accumulating thereupon. The rise in required circulation pressure (or the corresponding time period and/or changes in conductivity related thereto) is used to indicate the completion of the anode formation process. One- and two-dimensional implementations of cells are provided, and discharging efficiency may be enhanced by circulating the electrolyte during discharging.

The anode formation may be carried within the metal-air cell and does not require dismantling of the used cell. Removal of the used anode (or of used anode material) may be carried out through a dedicated sealable opening, yet during the anode formation the cell remains tightly closed and leak-proof.

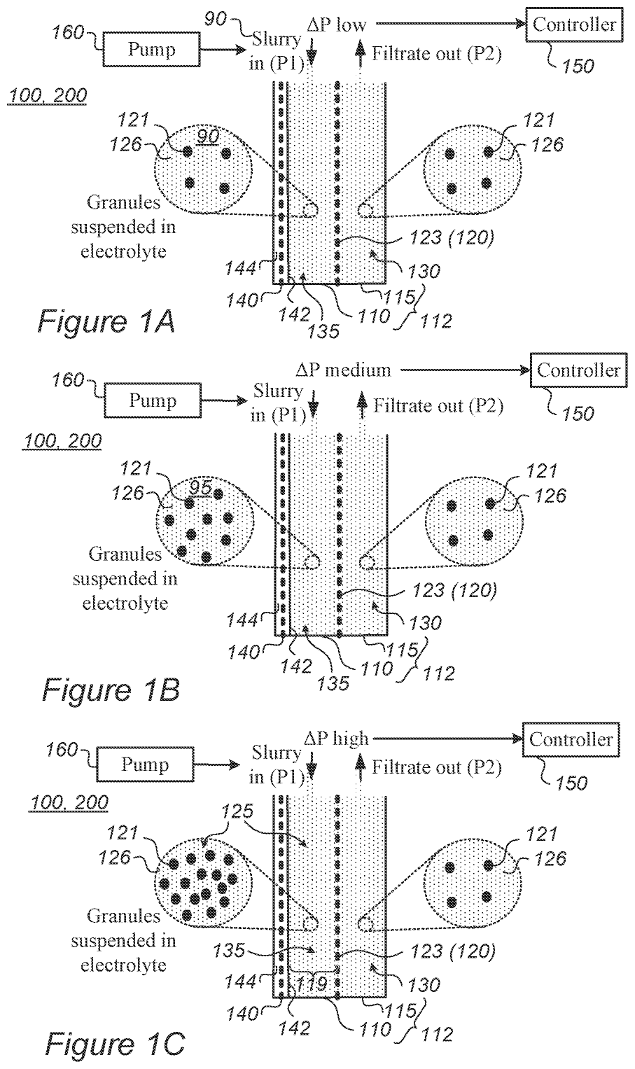

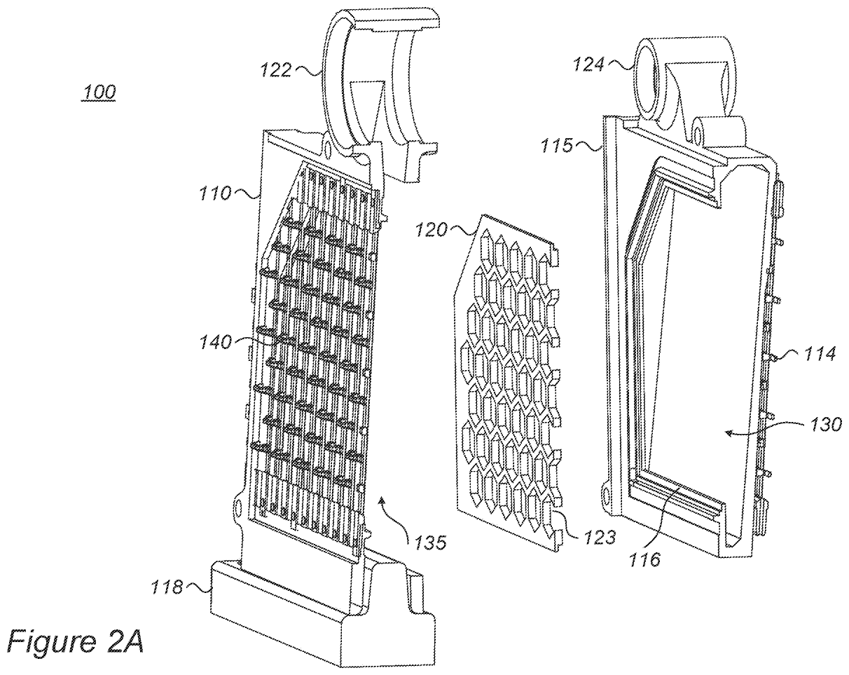

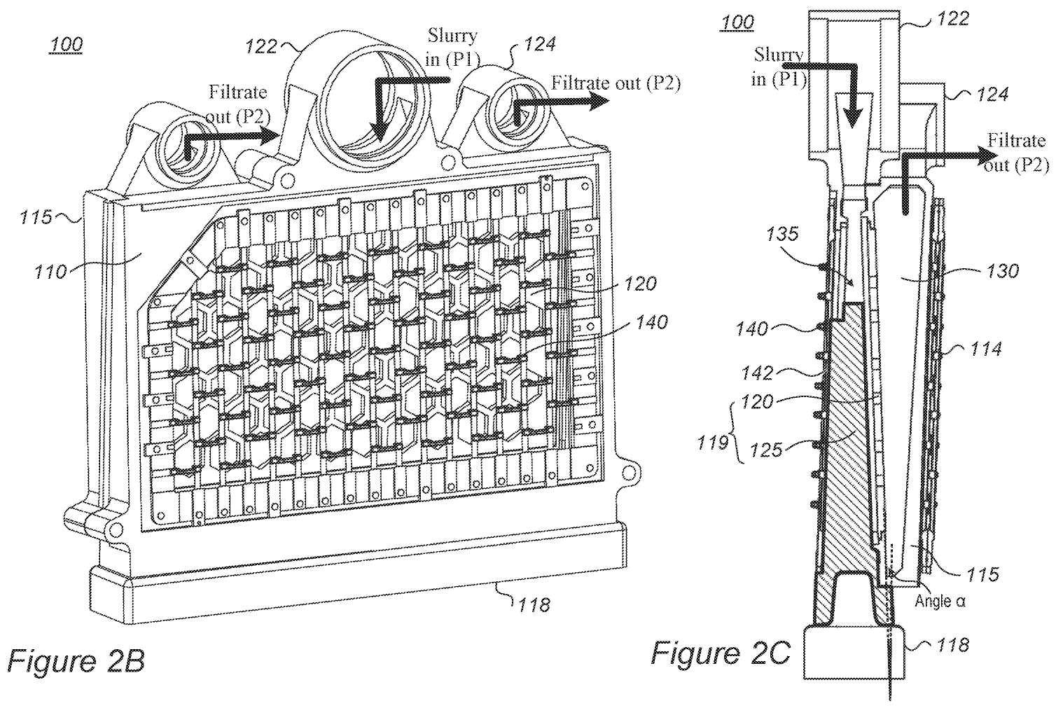

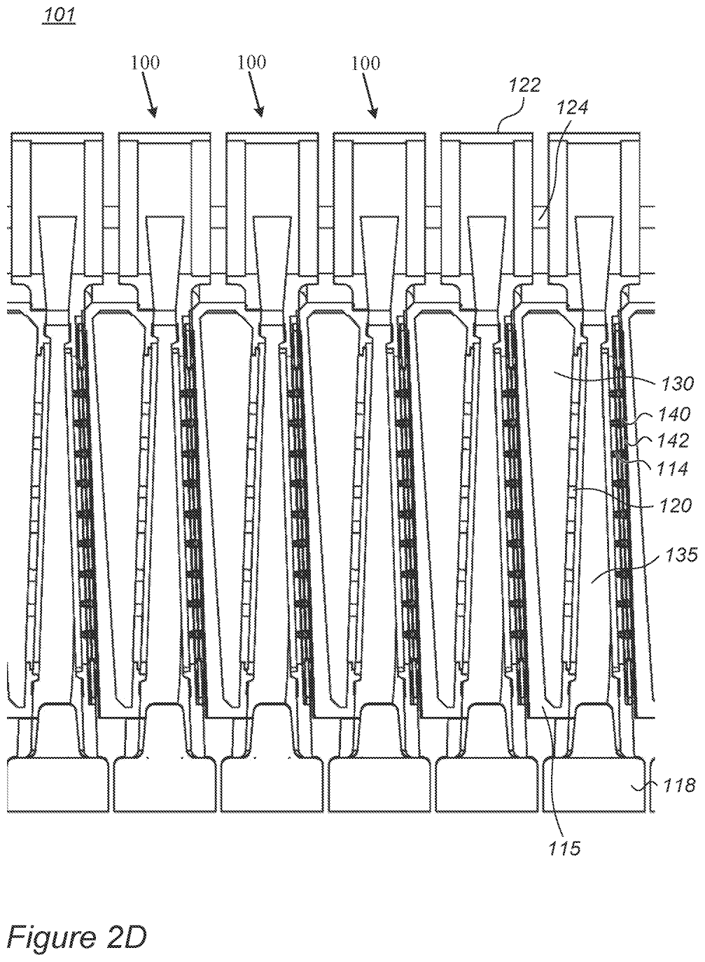

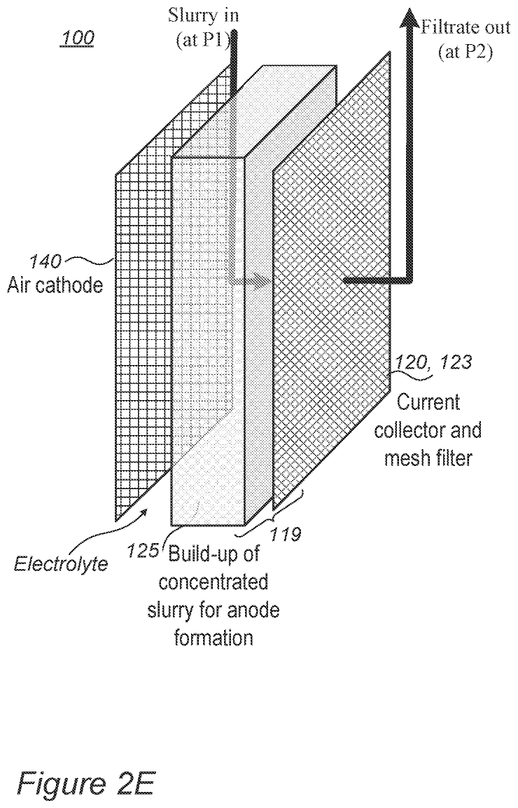

FIGS. 1A-1C are high-level schematic illustrations of a metal-air cell 100 and a method 200 of forming an anode 125 therein, according to some embodiments of the invention. FIGS. 1A, 1B and 1C schematically illustrate the start, middle and end, respectively, of the anode formation process within metal-air cell 100, provided by method 200. Metal-air cell 100 comprises at least one air cathode 140 with at least one associated separator 142, and at least one anode 119 that comprises at least one current collector 120 comprising at least one metal mesh 123 (see, e.g., FIGS. 1C, 2A and 2C) as well as a concentrated slurry 125 comprising metal granules 121 suspended in electrolyte 126 that is formed within a cell space volume 135 defined between separator(s) 142 associated with air cathode(s) 140 and current collector(s) 120. Concentrated slurry 125 forms and operates as anode 119 and is in electrical contact with current collector(s) 120 due to the gradual accumulation of metal granules at metal mesh 123. Cell space volume 135 is in fluid communication with a slurry entrance (122, e.g., in FIG. 2A-2D, 3A-3C), and, through metal mesh 123, in fluid communication with a filtrate exit (124, e.g., in FIG. 2A-2D, 3A-3C).

Metal-air cell 100 may be further configured to have cell space volume 135 configured to receive slurry 90 comprising electrolyte 126 and metal granules 121 through slurry entrance 122, for forming anode 119 of concentrated slurry 125. Anode(s) 119 further comprise current collector(s) 120 having metal mesh(es) 123 configured to filter the slurry to gradually increase a concentration of metal granules 121 in the slurry that is within cell space volume 135 and to enable the filtrate pass therethrough to filtrate exit 124, wherein the slurry is driven through cell space volume 135 by a pressure difference (ΔP) between a slurry introduction pressure (P1) and a filtrate exiting pressure (P2).

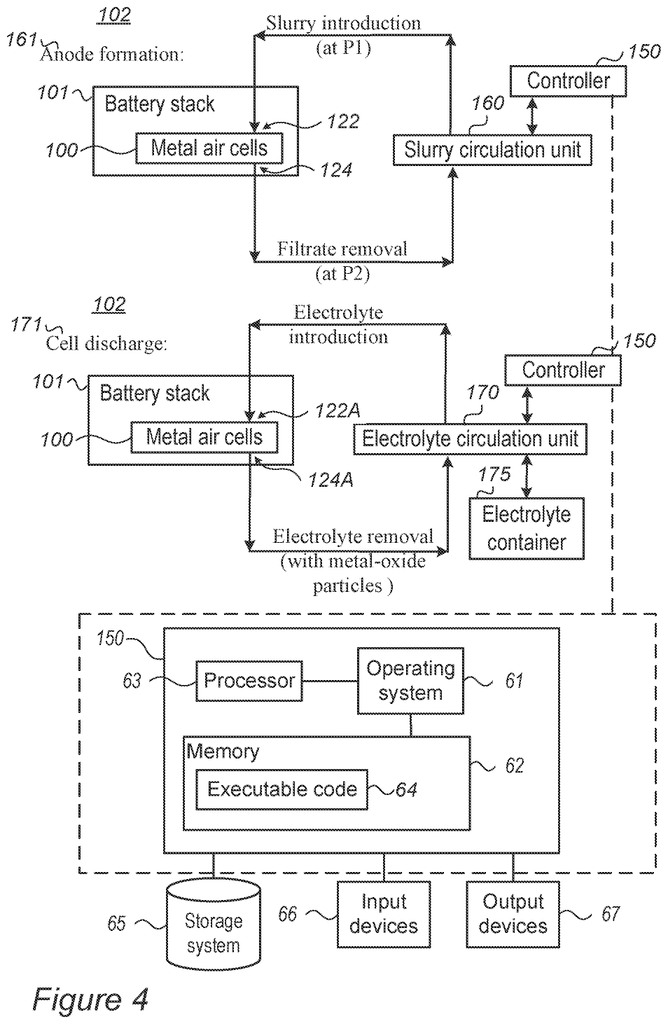

Certain embodiments comprise battery stacks 101 comprising a plurality of metal-air cells 100 (see, e.g., FIG. 2D) and/or battery system 102 comprising cells 100 and/or battery stacks 101, a slurry circulation unit 160 (e.g., pump 160) and a controller 150 (see, e.g., FIG. 4). Slurry circulation unit 160 (e.g., pump 160) may be configured to deliver slurry 90 to slurry entrance 122 at a first pressure P1 and remove the filtrate from filtrate exit 124 at a second pressure P2. Controller 150 may be configured to control P1 and/or P2 to control the formation of anode 119 according to specified parameters. For example, controller 150 may be configured to indicate a completed formation of anode 119 and/or completed accumulation of concentrated slurry 125 by detecting a pressure difference ΔP=P1−P2 reaching a specified threshold (e.g., between 30-200 mbar, between 60-100 mbar or intermediate values). Alternatively or complementarily, controller 150 may be configured to indicate a completed formation of anode 119 and/or completed accumulation of concentrated slurry 125 with respect to the time period that corresponds to the increase in pressure and/or changes in conductivity that relate to the accumulation of the metal granules, e.g., based on previous calibration measurements.

FIG. 1A illustrates schematically the beginning of the formation of anode 119, with slurry 90 having metal granules 121 suspended in electrolyte 126 being introduced into cell space 135 and removed as filtrate through complementary cell space 130 after passing through metal mesh 123, which gradually increases the concentration of metal granules 121 in cell space 135 by preventing some of metal granules 121 from passing through metal mesh 123. Initially, the pressure difference ΔP is small (e.g., few mbar, e.g., between 1 mbar and 10 mbar) as little metal granules accumulate within cell space 135, thus providing small resistance to the flow of slurry 90 through metal mesh 123.

FIG. 1B illustrates schematically the accumulation of metal granules 121 in cell space 135 (reaching an intermediate slurry concentration denoted schematically by numeral 95), while the filtrate may remain at the concentration of slurry 90, or rise more gradually (and typically only slightly) in complementary cell space 130 than in cell space 135. The pressure difference ΔP rises gradually to medium values (e.g., around 10 mbar or 20 mbar, possibly higher up to a few tens of mbar) as the resistance to the flow of slurry 90 through metal mesh 123 gradually rises with the accumulation of metal granules 121 within cell space 135, at metal mesh 123.

FIG. 1C illustrates schematically the further accumulation of metal granules 121 in cell space 135, which reaches the required slurry concentration for functioning as anode 119 in metal-air cell 100. The pressure difference ΔP further ises gradually to high values, which are used to indicate the end of the anode formation process—e.g., several tens of mbar or one or two hundred mbar at most, e.g., between 30 mbar and 200 mbar, or between 60 mbar and 100 mbar, or any other intermediate value.

It is noted that anode 119 is not solid, but comprises a concentrated slurry of metal granules 121 in electrolyte 126, ensuring high electrical conductivity throughout anode 119 as well as high ion conductivity among metal granules 121 throughout the volume of anode 119. Metal mesh 123 may be configured as a filtration barrier that traps metal particles 121 in slurry 90 and also to provide structure to support anode 119. Following the anode formation, electrolyte 126 remains between metal granules 126 and cathode(s) 140 (which is separated by separator 142 from electrolyte 126) and provides electrical and ionic conductivity between anode 119 and cathode 140. In non-limiting examples, initial slurry density (of slurry 90) may be around 1 vol % of the solid granules, and the final slurry density in anode 119 may reach a value between 10 vol % and 30 vol % of the solid granules.

The mesh size may be selected with respect to the particle size distribution of metal granules 121 to accumulate the particles in a short circulation time without requiring an excessive differential pressure (P1−P2). The pressure difference may be provided, e.g., by pump 160 configured to circulate slurry 90 and the filtrate. For example, the mesh size of metal mesh 123 may be between 50 μm and 400 μm, to correspond to the size of metal granules which may be between 50 μm and 400 μm. In non-limiting examples, the opening diameter in metal mesh 123 may be within any of 50-100 μm, 100-200 μm, 200-400 μm, or sub-ranges thereof, e.g., be distributed around any of 100 μm, 125 μm, 150 μm, or any other intermediate value. Typical sizes of the metal granules range between 100 μm and 2000 μm (2 mm) or sub-ranges thereof, typically with a granule size distribution that may facilitate the accumulation of the granules and the operation of the formed anode.

Metal granules 121 may comprise metal(s), metalloid(s), metal alloy(s), metal oxide(s) or combinations thereof. For example, metal granules 121 may comprise any of Zn, Fe, Mg or a combination thereof, as metal(s)/metalloid(s), alloy(s) thereof or oxide(s) thereof. For example, metal granules 121 may comprise Zn and/or ZnO (in the same or possibly different granules, with changing proportions during operation of the cell), and/or metal oxides of any of Zn(II), Fe(II) or Fe(III), Mg(II), or combinations thereof. Metal granules 121 may be uniform with respect to their metal type and content or may vary with respect to their metal type and content. In the non-limiting example of Zn/ZnO granules 121, Zn and ZnO may be present in the same particle or in different particles, e.g., metal granules 121 may comprise Zn particles with surface ZnO. Any of MgO, FeO and/or Fe₂O₃ may be used as alternative or in addition to ZnO. Electrolyte 126 may comprise alkaline electrolytes such as KOH, NaOH, or mixtures thereof.

Metal-air cell 100 may further comprise a cell casing 112, e.g., comprising a casing 110 partly enclosing cell space 135 and casing 115 partly enclosing complementary cell space 130, with casings 110, 115 sealably fitting to each other, optionally connectable to casing 112 of adjacent cells, and further configured to support at least cathode(s) 140, current collector(s) 120 (and/or metal mesh(es) 123), formed anode 119 and the circulation of slurry 90 through cell spaces 135, 130.

Metal-air cell 100 may further comprise a porous wall 144 (illustrated schematically) adjacent to air cathode(s) opposite to the cell space volume, the porous wall configured to enable delivering air and/or oxygen through the porous wall to the at least one air cathode.

FIGS. 2A-2E schematically illustrate embodiments of metal-air cells 100 and cell stacks 101 enabling formation of anodes 119 without dismantling cells 100, according to some embodiments of the invention. FIG. 2A is an exploded view, FIG. 2B is a perspective view and FIG. 2C is a cross-sectional side view-illustrating a non-limiting embodiment of metal-air cells 100, with casing 110 supporting cathode 140 and including slurry entrance 122 and casing 115 supporting metal mesh 123 and including filtrate exit 124. Cell space volume 135 may be defined by partial casing 110 that may support air cathode 140, and exiting filtrate may pass through second, complementary cell space 130 in fluid communication with filtrate exit 124. Second cell space 130 may be defined by partial casing 115 that may support current collector 120 (e.g., at seal 116). Partial casings 110 and 115 may be configured to interlock to yield full and sealed casing 112 for metal-air cell 100 and provide the fluid communication to slurry entrance 122 and filtrate exit 124, respectively. Metal-air cell 100 may further comprise a porous wall 114 adjacent to air cathode 140 (opposite to cell space volume 135), and configured to enable delivering air and/or oxygen through the porous wall to air cathode 140. Metal-air cell 100 may further comprise a base 118 configured to be removable, or including a sealable opening to cell space volume 135 to enable evacuation of consumed anode material from cell space volume 135. It is noted that the indication of anode 119 in FIGS. 1C, 2C, 2E and 3D is highly schematic, indicating the current collector(s) and the region of concentrated slurry accumulation and is not limiting.

Certain embodiments comprise a battery stack 101 comprising a plurality of metal-air cells 100, as illustrated schematically, e.g., in FIG. 2D (a cross-sectional side view). Partial casings 110 and 115 of each metal-air cell 100 may be configured to interlock and stabilize battery stack 101, with base 118 optionally common to all metal-air cells 100, or comprising interlocking bases 118, optionally with respective sealable openings for removing consumed anode material. Second cell space 130 may comprise a supporting grid 114 delimiting porous wall 144, configured to support air cathode 140 and/or provide access to oxidant such as air and/or oxygen to air cathode 140.

FIG. 2E illustrates schematically the principle of anode material accumulation from delivered slurry, in the space defined between air cathode 140 and current collector 120 which is also configured to filter the delivered slurry to accumulate metal granules 121 within cell space volume 135, utilizing the rising pressure difference (ΔP=P1−P2) to indicate the degree of accumulation of metal granules 121 into anode 119. The pressure difference (P1−P2) may be used as indicator for the completion of the anode formation process.

In a range of hydraulic experiments, anode formation was found to be feasible and yielding efficient anodes. Parameters of the cells and of the anode formation process were evaluated with respect to cell performance indicators. Without being bound to theory, the various parameters may influence the rate of accumulation of anode material and/or the rate of removal of used, or oxidized anode material (during charging) and by adjusting the parameters optimal design of the systems and cells may be achieved. For example, the angle of current collector 120 (denoted as the angle a in FIG. 2C) was modified between 1° and 2.5°, opening diameter in metal mesh 123 were modified between 125 μm and 250 μm, the slurry pump flow rate was modified between 25 l/min and 32 l/min, the pressure difference ΔP was measured between 45 mbar and 170 mbar, etc. The resulting anodes were between 400 ml and 500 ml in volume and between 725 gr and 1995 gr in mass (formed within 1-7 minutes depending on the other parameters)—yielding anode densities between 7% v/v and 46% v/v, of which the range between 10-20% v/v was found to provide the optimal discharging performance.

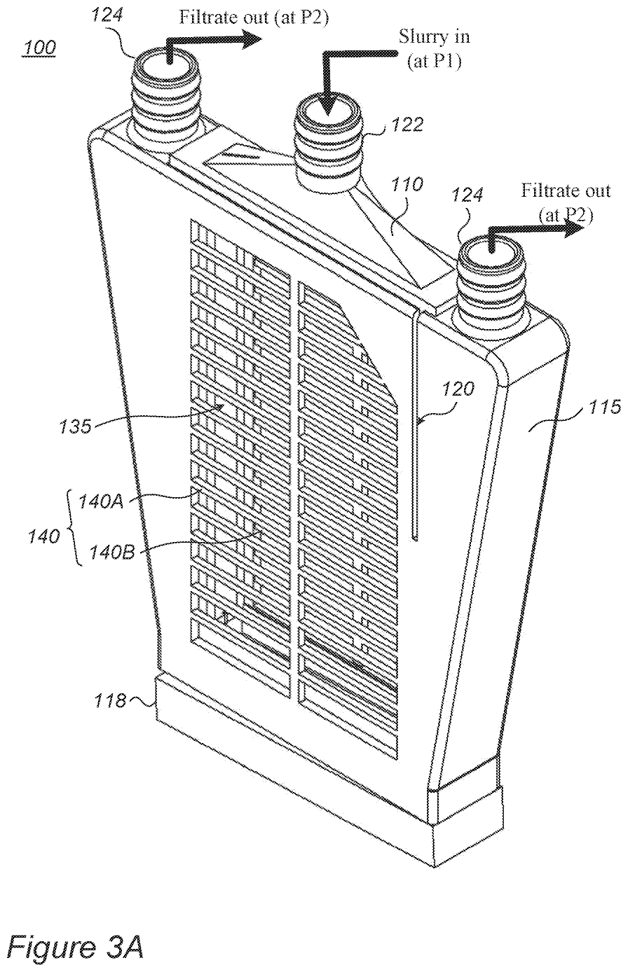

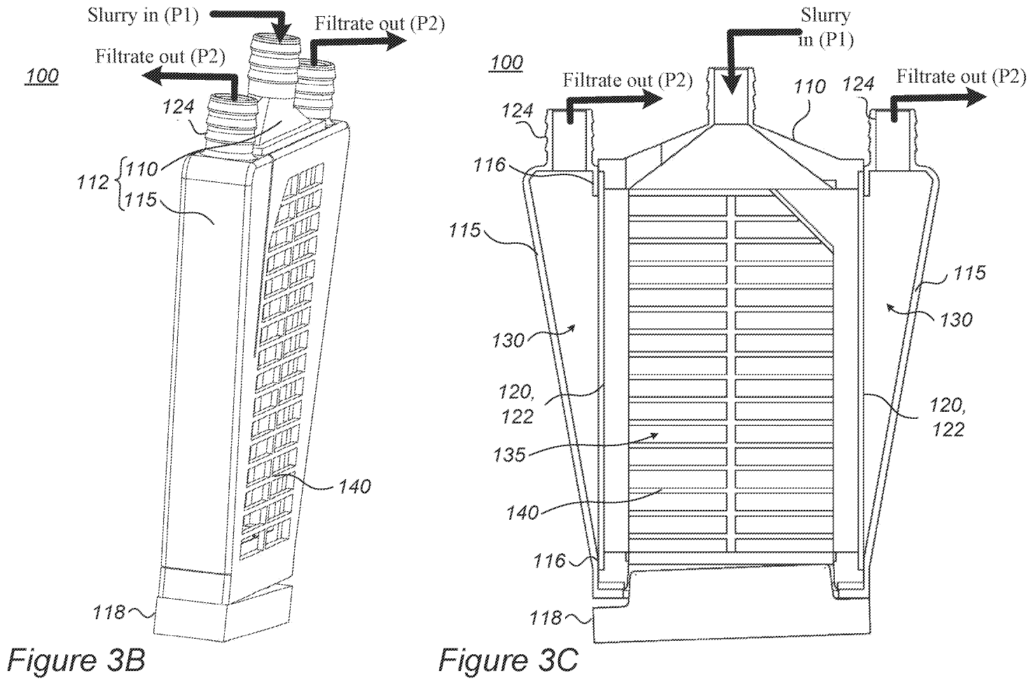

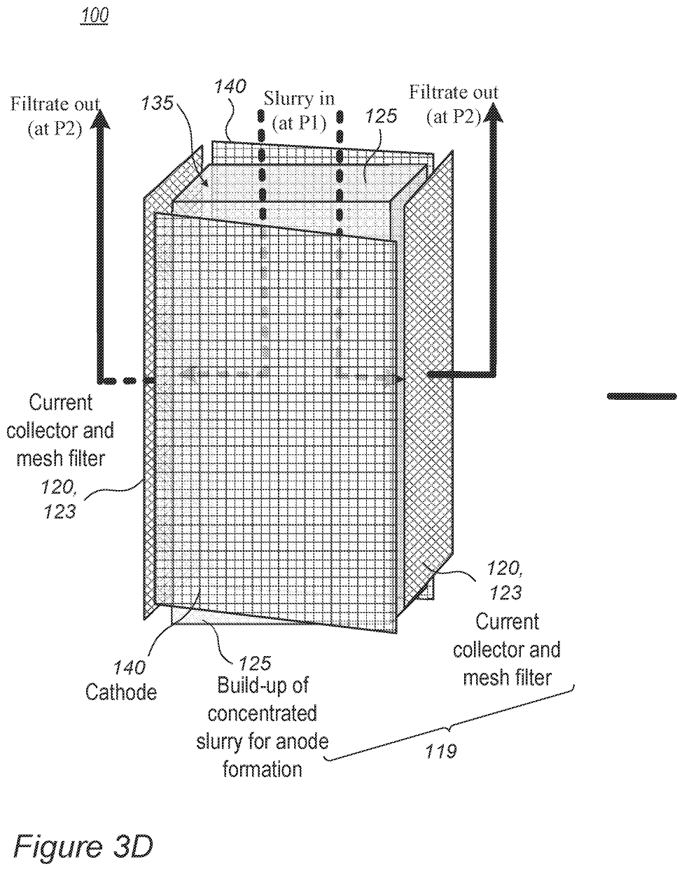

FIGS. 3A-3D schematically illustrate embodiments of metal-air cells 100 enabling anode formation without dismantling the cell, according to some embodiments of the invention. Metal-air cells 100 may comprise two air cathodes 140, and anode(s) 119 comprising two current collectors 120, each comprising metal mesh 123 (illustrated schematically in FIG. 3D) and concentrated slurry 125. Cell space volume 135 may be defined between air cathodes 140 and current collectors 120, and be in fluid communication with slurry entrance 122, and, through metal meshes 123, in fluid communication with filtrate exits 124. Cell space volume 135 may be configured to receive slurry 90 comprising metal granules 121 suspended in electrolyte 126 through slurry entrance 122 and concentrate metal granules 121 by filtering through metal meshes 123, leaving at least part of metal granules 121 within cell space volume 135 and letting the filtrate pass therethrough to filtrate exits 124, as illustrated schematically in FIGS. 1A-1C. Metal meshes 123 may be configured as a filtration barrier that traps metal particles 121 from slurry 90 as well as a structure on which anode 119 is built on. FIGS. 3A-3D provide a non-limiting two-dimensional implementation of the principle illustrated schematically in FIGS. 1A-1C.

The pressure difference (ΔP=P1−P2) between the slurry introduction pressure (P1) and the filtrate exiting pressure (P2) rises during the accumulation of metal granules 121 to form anode 119 of metal-air cell 100 (see, e.g., FIG. 3D), with the slurry contacting current collectors 120 by its accumulation on metal meshes 123. As anode 119 comprises a concentrated suspension of metal granules 121 in electrolyte 126, electrolyte inherently separates metal granules 121 from separators 142 associated with air cathodes 140 (not shown in FIGS. 3A-3D, see FIGS. 1A-1C). The mesh size may be selected with respect to the particle size distribution of metal granules 121 to accumulate the particles in a short circulation time without reaching an excessive differential pressure. For example, the mesh size of metal mesh 123 may be between 50 μm and 400 μm, to correspond to the size of metal granules which may be between 50μm and 400 μm. In non-limiting examples, the opening diameter in metal mesh 123 may be within any of 50-100 μm, 100-200 μm, 200-400 μm, or sub-ranges thereof, e.g., be distributed around any of 100 μm, 125 μm, 150 μm, or any other intermediate value. Typical sizes of the metal granules range between 100 μm and 2000 μm (2 mm) or sub-ranges thereof, typically with a granule size distribution that may facilitate the accumulation of the granules and the operation of the formed anode.

As illustrated schematically in FIGS. 3B and 3C, cell space volume 135 may be defined by partial casing 110 that may support air cathodes 140, and exiting filtrate may pass through secondary cell spaces 130 in fluid communication with filtrate exits 124. Secondary cell spaces 130 may be defined by partial casings 115 that may support respective current collectors 120 (e.g., at seal 116). Partial casings 110 and 115 may be configured to interlock to yield full and sealed casing 112 for metal-air cell 100 and provide the fluid communication to slurry entrance 122 and filtrate exits 124, respectively. Metal-air cell 100 may further comprise a base 118 configured to be removable, or including a sealable opening to cell space volume 135 to enable evacuation of consumed anode material from cell space volume 135.

In various embodiments, two air cathodes 140 may be parallel to each other and/or two current collectors 120 may be parallel to each other. In various embodiments, two air cathodes 140 may be parallel to each other and two current collectors 120 may be parallel to each other and perpendicular to the air cathodes 140. Cell space volume 135 (and renovated anode 119) may be shaped as at last a partial parallelepiped defined by two air cathodes 140 and two current collectors 120, possibly with air cathodes 140 having a larger area than current collectors 120. In certain embodiments, current collectors 120 may provide the narrow dimension of cells 100, while air cathodes 140 may provide the wide dimension of cells 100.

Certain embodiments comprise battery stack 101 (not shown, constructed similarly as illustrated schematically in FIG. 2D) comprising a plurality of metal-air cells 100. Partial casings 110 and 115 of each metal-air cell 100 may be configured to interlock and stabilize the battery stack, with base 118 optionally common to all metal-air cells 100, or comprising interlocking bases 118, optionally with respective sealable openings for removing consumed anode material.

FIG. 3D illustrates schematically anode material accumulation from delivered slurry 90, according to some embodiments of the invention. Metal granules 121 (suspended in electrolyte 126) may be concentrated in space 135 defined between air cathodes 140 and current collectors 120, the latter being configured to filter delivered slurry 90 to accumulate metal granules within cell space volume 135 and utilize the pressure difference (P1−P2) to indicate the degree of the accumulation of metal granules 121 into concentrated slurry 125 that forms anode 119.

FIG. 4 is a high-level schematic illustration of a battery system 102, according to some embodiments of the invention. Battery system 102 in its anode formation stage 161 may comprise a battery stack 101 with metal-air cells 100, a slurry circulation unit 160 configured to deliver slurry 90 to slurry entrance(s) 122 at the first pressure (P1) and remove the filtrate from filtrate exit(s) 124 at the second pressure (P2), and a controller 150 configured to control at least one of the first and second pressures (P1, P2) to control the formation of the anodes in metal-air cells 100 according to specified parameters, such as by detecting the pressure difference ΔP=P1−P2 reaching a specified threshold, e.g., the threshold being between 30-200 mbar, between 60-100 mbar or at intermediate values.

In certain embodiments, battery system 102 in its cell discharge stage 171 may comprise battery stack 101 with metal-air cells 100, an electrolyte circulation unit 170 configured to circulate the electrolyte through the metal-air cells during discharging thereof, to remove oxidized metal granules from the concentrated slurry. Electrolyte circulation unit 170 may be configured to deliver electrolyte to electrolyte entrance(s) 122A (which may correspond to at least some of slurry entrance(s) 122) and remove the electrolyte from electrolyte exit(s) 124 (which may correspond to at least some of filtrate exit(s) 124) with (used metal-oxide particles), and controller 150 configured to control the introduction and removal of electrolyte by electrolyte circulation unit 170, e.g., from and to an electrolyte container 175. Electrolyte container 175 may have a larger volume than metal-air cells 100, from and to which the electrolyte is circulated during discharge.

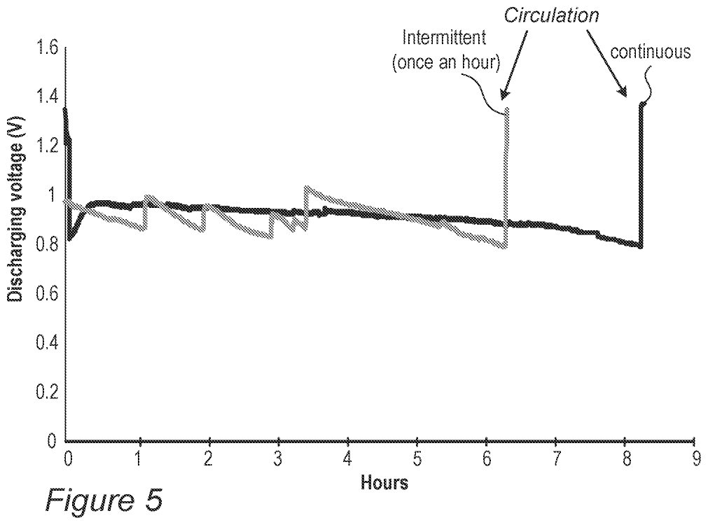

Circulation of electrolyte during cell discharge may be utilized to remove used anode particles (e.g., oxidized metal granules 121) from concentrated slurry 125 that forms anode 119. As oxidized particles are typically much smaller than unoxidized particles, the circulation of electrolyte during cell discharge typically removes many more oxidized (used) particles than unoxidized particles. Advantageously, removing used anode particles increases the effective electrolyte contact area of the remaining active metal granules 121 in anode 119 and therefore increases the extent of available discharge from the cell. It is noted that as the volume of electrolyte in electrolyte container 175 is typically much larger than the volume of electrolyte in cells 100, at least most of the removed used particles are retained within electrolyte container 175 and are not circulated back into the cells. In various experimental settings, continuous circulation was shown to provide better discharging performance (see, e.g., FIG. 5). In certain embodiments, the used particles may be reduced to provide fresh metal particles, for re-introduction to form anode 119 in following cycles.

FIG. 4 further includes a high-level block diagram of exemplary controllers 150, which may be used with embodiments of the present invention. Controller(s) 150 may include one or more processor 63 that may be or include, for example, one or more central processing unit processor(s) (CPU), one or more Graphics Processing Unit(s) (GPU or general-purpose GPU-GPGPU), a chip or any suitable computing or computational device, an operating system 61, a memory 62, a storage 65, input devices 66 and output devices 61.

Operating system 61 may be or may include any code segment designed and/or configured to perform tasks involving coordination, scheduling, arbitration, supervising, controlling, or otherwise managing operation of controller(s) 150, for example, scheduling execution of programs. Memory 62 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 62 may be or may include a plurality of possibly different memory units. Memory 62 may store for example, instructions to carry out a method (e.g., code 64), and/or data such as user responses, interruptions, etc.

Executable code 64 may be any executable code, e.g., an application, a program, a process, task or script. Executable code 64 may be executed by controller 63 possibly under control of operating system 61. For example, executable code 64 may when executed cause the production or compilation of computer code, or application execution such as VR execution or inference, according to embodiments of the present invention. Executable code 64 may be code produced by methods described herein. For the various modules and functions described herein, one or more computing devices and/or components of controller(s) 150 may be used. Devices that include components similar or different to those included in controller(s) 150 may be used and may be connected to a network and used as a system. One or more processor(s) 63 may be configured to carry out embodiments of the present invention by for example executing software or code.

Storage 65 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, VR model data, parameters, etc. may be stored in a storage 65 and may be loaded from storage 65 into a memory 62 where it may be processed by controller 63. In some embodiments, some of the components shown in FIG. 4 may be omitted.

Input devices 66 may be or may include for example a mouse, a keyboard, a touch screen or pad or any suitable input device. It will be recognized that any suitable number of input devices may be operatively connected to controller(s) 150 as shown by block 66. Output devices 61 may include one or more displays, speakers and/or any other suitable output devices. It will be recognized that any suitable number of output devices may be operatively connected to controller(s) 150 as shown by block 61. Any applicable input/output (I/O) devices may be connected to controller(s) 150, for example, a wired or wireless network interface card (NIC), a modem, printer or facsimile machine, a universal serial bus (USB) device or external hard drive may be included in input devices 66 and/or output devices 61.

Embodiments of the invention may include one or more article(s) (e.g., memory 62 or storage 65) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

FIG. 5 provides experimental examples for improved discharging under continuous electrolyte circulation, according to some embodiments of the invention. FIG. 5 provides results of two discharging operations of respective single cells over several hours, one with hourly circulation of electrolyte through the cell (intermittent circulation, once every hour) and another with continuous circulation through the discharging operation—indicating that the latter provide longer and more even discharging of the cell—which is preferrable.

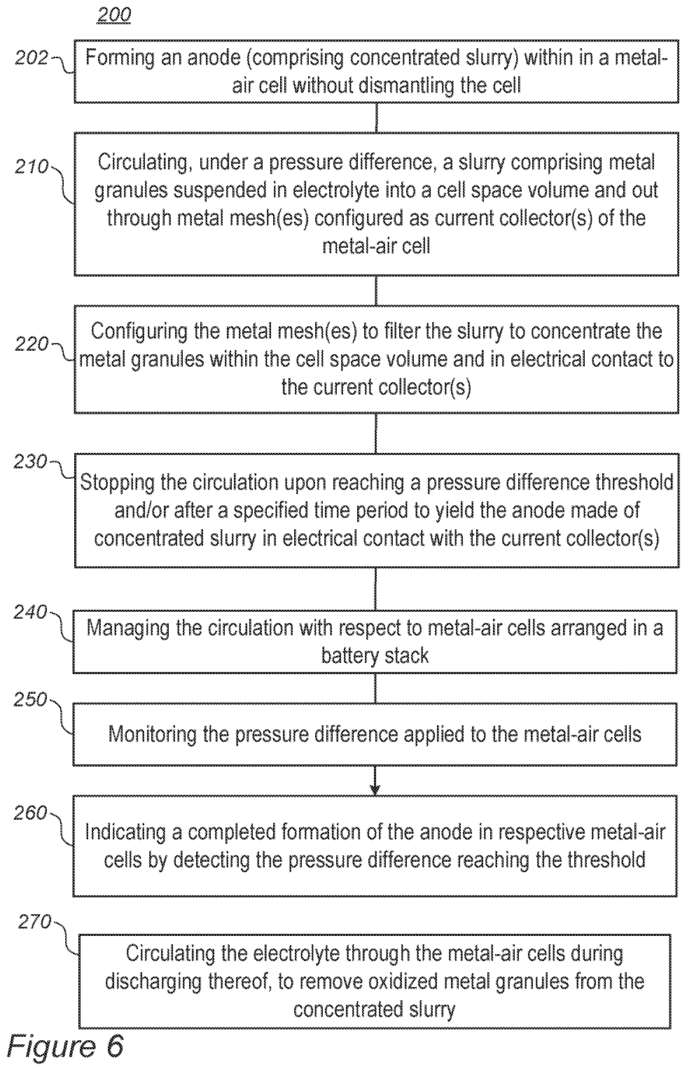

FIG. 6 is a high-level flowchart illustrating a method 200 of forming an anode within a metal-air cell without dismantling the cell (stage 202), according to some embodiments of the invention. The method stages may be carried out with respect to disclosed metal-air cells 100 and systems 102 described herein, which may optionally be configured to implement method 200. Method 200 may be at least partially implemented by at least one computer processor, e.g., in a controller 150. Certain embodiments comprise computer program products comprising a computer readable storage medium having computer readable program embodied therewith and configured to carry out the relevant stages of method 200. Method 200 may comprise the following stages, irrespective of their order.

Method 200 may comprise circulating, under a pressure difference, a slurry comprising metal granules suspended in electrolyte into a cell space volume and out through at least one metal mesh configured as at least one current collector of the metal-air cell (stage 210), wherein the metal mesh is configured to filter slurry to concentrate the metal granules within the cell space volume (stage 220). Method 200 further comprises stopping the circulation upon reaching a pressure difference threshold to yield the anode comprising a concentrated slurry, the anode being in electrical contact with the at least one current collector (stage 230). Stopping the circulation may be carried out after a specified time period, determined, e.g., in preparatory tests. The cell space volume is defined between the at least one separator associated with at least one air cathode and the at least one current collector, and is in fluid communication with a slurry entrance, and, through the metal mesh, in fluid communication with a filtrate exit of the metal-air cell.

Method 200 may further comprise managing the circulation with respect to a plurality of metal-air cells arranged in a battery stack (stage 240, e.g., in battery stack 101), e.g., by monitoring the pressure difference applied to the metal-air cells (stage 250) and indicating a completed formation of the anode in respective metal-air cells by detecting the pressure difference reaching the threshold (stage 260).

It is noted that the pressure difference mainly supports the circulation of the slurry through the metal-air cells, and gradually rises as the metal granules accumulate of the metal mesh to form the anode. Possibly some compaction of the metal granules occurs as they accumulate, yet the anode stays in concentrated slurry form when formed upon stopping 230.

In certain embodiments, method 200 may further comprise circulating the electrolyte through the metal-air cells during discharging thereof, to remove oxidized metal granules from the concentrated slurry (stage 270).

Elements from any of FIGS. 1A-6 may be combined in any operable combination, and the illustration of certain elements in certain figures and not in others merely serves an explanatory purpose and is non-limiting.

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram or portions thereof.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A metal-air cell comprising:
at least one air cathode with at least one associated separator, and
at least one anode comprising:
at least one current collector comprising at least one metal mesh, and
a concentrated slurry comprising metal granules suspended in electrolyte that is accumulated within a cell space volume defined between the at least one separator associated with the at least one air cathode and the at least one current collector, the concentrated slurry being in electrical contact with the at least one current collector and the cell space volume being in fluid communication with a slurry entrance, and, through the metal mesh, in fluid communication with a filtrate exit.

2. The metal-air cell of claim 1, wherein:
the cell space volume is configured to receive a slurry comprising electrolyte and metal granules through the slurry entrance,
the metal mesh is configured to filter the slurry to gradually increase a concentration of the metal granules in the slurry that is within the cell space volume and to enable the filtrate pass therethrough to the filtrate exit, and
the slurry is driven through the cell space volume by a pressure difference between a slurry introduction pressure and a filtrate exiting pressure.

3. The metal-air cell of claim 1, further comprising a porous wall adjacent to the at least one air cathode opposite to the cell space volume, the porous wall configured to enable delivering air and/or oxygen through the porous wall to the at least one air cathode.

4. The metal-air cell of claim 1, further comprising a sealable opening to the cell space volume, the sealable opening configured to enable evacuation of consumed anode material from the cell space volume.

5. The metal-air cell of claim 1, wherein the metal granules slurry comprises electrolyte, metal particles, metal-oxide particles and additives.

6. The metal-air cell of claim 1, wherein the metal granules slurry comprises at least one of Zn, Fe, Mg.

7. The metal-air cell of claim 1, wherein:
the at least one air cathode with at least one associated separator comprises one air cathode with an associated separator, and
the at least one current collector comprises one current collector.

8. The metal-air cell of claim 1, wherein:
the at least one air cathode with at least one associated separator comprises two air cathodes with associated separators,
the at least one current collector comprises two current collectors, and
the cell space volume is defined between the two air cathodes and the two current collectors.

9. The metal-air cell of claim 8, wherein the two air cathodes are parallel to each other and/or the two current collectors are parallel to each other.

10. (canceled)

11. The metal-air cell of claim 8, wherein
the two air cathodes are parallel to each other, and
the two current collectors are parallel to each other and perpendicular to the two air cathodes.

12. The metal-air cell of claim 11, wherein the cell space volume is a parallelepiped defined by the two air cathodes and the two current collectors.

13. The metal-air cell of claim 12, wherein the air cathodes have a larger area than the current collectors.

14. A battery stack comprising a plurality of the metal-air cells of claim 1.

15. A battery system comprising:
the battery stack of claim 14,
a slurry circulation unit configured to deliver the slurry to the slurry entrance at a first pressure P1 and remove the filtrate from the filtrate exit at a second pressure P2, and
a controller configured to control at least one of the first and second pressures to control the accumulation of the metal granules of the concentrated according to specified parameters.

16. The battery system of claim 15, wherein the controller is further configured to indicate a completed concentration of the slurry by detecting a pressure difference ΔP=1−P2 reaching a specified threshold.

17. The battery system of claim 15, wherein the controller is further configured to indicate a completed concentration of the slurry with respect to a time period that is required for a completed concentration of the slurry and/or with respect to changes in conductivity related thereto.

18. The battery system of claim 15, further configured to circulate the electrolyte through the metal-air cells during discharging thereof, to remove oxidized metal granules from the concentrated slurry.

19. The battery system of claim 18, further comprising an electrolyte container having a larger volume than the metal-air cells, from and to which the electrolyte is circulated during discharge.

20. A method of forming an anode within a metal-air cell without dismantling the cell, the method comprising:
circulating, under a pressure difference, a slurry comprising metal granules suspended in electrolyte into a cell space volume and out through at least one metal mesh configured as at least one current collector of the metal-air cell, wherein the metal mesh is configured to filter slurry to concentrate the metal granules within the cell space volume, and
stopping the circulation upon reaching a pressure difference threshold or a specified time period to yield the anode comprising a concentrated slurry and the at least one current collector, being in electrical contact,
wherein the cell space volume is defined between the at least one separator associated with at least one air cathode and the at least one current collector, and is in fluid communication with a slurry entrance, and, through the metal mesh, in fluid communication with a filtrate exit of the metal-air cell.

21. The method of claim 20, further comprising managing the circulation with respect to a plurality of metal-air cells arranged in a battery stack and monitoring the pressure difference applied to the metal-air cells and indicating a completed formation of the anode in respective metal-air cells by detecting the pressure difference reaching the threshold.

22. (canceled)

23. (canceled)
